(19) United States
(12) Patent Application Publication
(10) Pub. No.: US 2016/0019548 A1
(43) Pub. Date: Jan. 21, 2016

(54) Secure Electronic Identification Device

(71) Applicant: Joseph M. Gangi, Bristol, RI (US)

(72) Inventor: Joseph M. Gangi, Bristol, RI (US)

(21) Appl. No.: 14/799,356

(22) Filed: Jul. 14, 2015

Related U.S. Application Data
(63) Continuation-in-part of application No. 13/902,834, filed on May 26, 2013, now Pat. No. 9,111,082.

(51) Int. Cl. G06Q 20/40; G06Q 20/10; H04L 29/06

(52) U.S. Cl. CPC G06Q 20/40145; H04L 63/0861; G06Q 20/4012; G06Q 20/108

(57) ABSTRACT

In accordance with one embodiment of the present invention a secure electronic identification device (SEID) is presented. The SEOD includes a display mode for displaying government furnished information, a display mode for displaying user furnished information, and a public display mode for displaying public information. The SEID also includes a banking module with logic and resources for initiating financial transactions between the SEID and a payment gateway. The SEID includes a removable card having a magnetic strip and an EMV chip encodable by the SEID.

### CROSS-REFERENCE TO RELATED APPLICATIONS

The present application is related to, claims the earliest available effective filing date(s) from (e.g., claims earliest available priority dates for other than provisional patent applications; claims benefits under 35 USC §119(c) for provisional patent applications), and incorporates by reference in its entirety all subject matter of the following listed application(s) (the “Related Applications”) to the extent such subject matter is not inconsistent herewith; the present application also claims the earliest available effective filing date(s) from, and also incorporates by reference in its entirety all subject matter of any and all parent, grandparent, great-grandparent, etc. applications of the Related Application(s) to the extent such subject matter is not inconsistent herewith:

This application is a continuation-in-part of U.S. patent application Ser. No. 13/902,834 entitled “Secure identification Card (SEID) System”, naming Joseph M. Gangi as inventor, filed 26 May 2013.

### BACKGROUND

1. Field of Use

The presently disclosed subject matters relates to Identification cards, mobile applications, and mobile devices such as mobile phones, Personal Digital Assistants (PDAs), iPods, tablet computers, laptop computers, and similar mobile devices. More particularly, the subject matter relates to a secure identification device which can be used at any type of terminal equipped with a magnetic stripe reader or a short range wireless communication capability.

2. Description of Prior Art (Background)

Authentication of an individual's identity is a fundamental component of physical and logical access control processes. A wide range of mechanisms is employed to authenticate identity, utilizing various classes of identity credentials. For physical access, individual identity has traditionally been authenticated by use of paper or other non-automated, hand-carried credentials, such as driver's licenses and badges. Access authorization to computers and data has traditionally been authenticated through user-selected passwords. More recently, cryptographic mechanisms and biometric techniques have been used in physical and logical security applications, replacing or supplementing the traditional credentials.

The strength of the authentication that is achieved varies, depending upon the type of credential, the process used to issue the credential, and the authentication mechanism used to validate the credential. This specification establishes a standard for a Secure Electronic Identification Device (SEID) based on secure and reliable forms of identification credentials issued and maintained by a state or local government entity. The SIC-C is intended to authenticate an individual's identification.

Homeland Security Presidential Directive 12 [HSPD 12], signed by the President on Aug. 27, 2004, established the requirements for a common identification standard for identification credentials issued by Federal departments and agencies to Federal employees and contractors (including contractor employees) for gaining physical access to Federally controlled facilities and logical access to Federally controlled information systems. HSPD 12 directs the Department of Commerce to develop a Federal Information Processing Standards (HIPS) publication to define such a common identification credential. In accordance with HSPD 12, the FIPS standard defines the technical requirements for the identity credential that
Is issued based on sound criteria for verifying an individual employee's identity
Is strongly resistant to identity fraud, tampering, counterfeiting, and terrorist exploitation
Can be rapidly authenticated electronically
Is issued only b providers whose reliability has been established by an official accreditation process.

The FIPS standard defines authentication mechanisms offering varying degrees of security. Federal departments and agencies determine the level of security and authentication mechanisms appropriate for their applications. The ID cards issued by the Federal government are generally referred to as Common Access Cards or CAC cards.

However, CAC cards require a master database or locally stored active directory coupled with a Personal identification Number (PIN) in order to determine a user's ID. In addition, CAC cards do not provide a user accessible area to store other user data, such as driver license numbers or a public area to store data such medical alert data in the event of an emergency. CAC cards do not provide a GPS locator feature.

In addition, CAC cards require sophisticated printing techniques in order to provide visual authentication that the card has not been tampered with; e.g., CAC security features include, at a minimum:
Optical varying structures
Optical varying inks
Laser etching and engraving
Holograms
Holographic images
Watermarks.

It will be appreciated that incorporating printed security features such as watermarks, holographic images, etc., is expensive and time consuming. Moreover, once of these features has been compromised it is not a simple matter to recall and reprint security cards implementing the compromised security feature.

It is desirable, therefore, to provide a secure identification card having multiple access areas. It is also desirable to provide a secure identification card having GPS locator capability.

### BRIEF SUMMARY

The foregoing and other problems are overcome, and other advantages are realized, in accordance with the presently preferred embodiments of these teachings.

The SEID invention is directed towards a durable enclosure with a visible touch screen capability (capacitive or resistive) and a GPS transmitter. The SEID has a credit card-size form factor, with one or more embedded integrated circuit chips (ICC) that provide memory capacity and computational capability. The holder uses the SEID for authentication and other purposes. The SEID has three primary data storage areas: a private memory storage area for storing user Personal identification Information (PII) data; a public memory area accessible for storing emergency data such as medical information in the event of an emergency; and a government memory area for providing secure storage area accessible only by a government agency. PII data may include any suitable information defined to be personal information, e.g., addresses, phone numbers, age, etc.

One of the primary features of the SEID will be fingerprint recognition initiation for authenticating owner's private data such as driver's license and/or identification card, social security card, and the ability to upload individual's personal medical records. The driver's license portion in itself will be a secure government upload to the government memory area initiated through an office of legal authority.

Therefore, fingerprint registration is accomplished when the government identification is uploaded to the device. This is a separate application and secure upload from any other personal data, therefore, keeping certain records, such as, for example, secure drivers license, protected through government encryption technology.

The SEID contains GPS 911 tracking for multiple purposes, for example, loss of unit. A web site or toll free number with password or biometric user verification can be used to access information regarding the location of the device. Finally, it could have an interactive alert feature for emergency purposes.

In accordance with one embodiment of the present invention a secure electronic identification device is provided. The device includes a housing having a display on an outer side of the housing for displaying selected public, government, or user supplied data in the form of images representing public, government, or user cards, such as, for example, driver's license, social security cards, permits, library cards, credit cards, bank cards, and store cards. The secure electronic identification device also provides an inner circuit, inside the housing, for providing communication and display functions. In addition, the secure electronic identification device includes at least one secure memory area accessible by government systems for storing the government furnished information. Also included are at least one user-secured memory area for storing the user furnished information and at least one public memory area for storing the public information. The secure electronic identification device also includes a hi-stable electrophoretic display or an LED display for displaying the government, user, or public information. The aforementioned inner circuit includes the logic and resources to minimize display power consumption. In addition, the aforementioned inner circuit also includes the logic and resources to verify the source or authenticity of the government, user, or public furnished information. Also included in the secure electronic identification device is an LED or I/O port for transmitting or receiving the government, user, or public furnished information. The I/o port may be a powered USB port for charging the secure electronic identification device.

In accordance with one embodiment of the present invention a secure electronic identification device is provided. The device includes a housing having a display on an outer side of the housing for displaying selected public, government, or user supplied data in the form of images representing public, government, or user cards, such as, for example, driver's license, social security cards, permits, library cards, credit cards, bank cards, and store cards. The secure electronic identification device also provides an inner circuit, inside the housing, for providing communication and display functions. In addition, the secure electronic: identification device includes at least one secure memory area accessible by government systems for storing the government furnished information. Also included are at least one user-secured memory area for storing the user furnished information and at least one public memory area for storing the public information. The inner circuit further comprises an EMV Smart Card for implementing a global standard for inter-operation of integrated circuit cards (IC cards or “chip cards”) and IC card capable point of sale (POS) terminals and automated teller machines (ATMs), for authenticating credit and debit card transactions; a subscriber identification module (SIM) for storing a mobile subscriber identity and related key for identification and authentication; a general packet radio service (GPRS), and a global positioning satellite (GPS) module for locating the securable electronic identification device. The inner circuit also includes a secure card for access by a government system for identity proofing and registration; a memory area for storing the government, public, or user information; and a controller for controlling access to, including encrypting or decrypting, the government, public, or user information. The device also includes logic and resources for comparing and evaluating PINs and/or biometric data stored within the securable electronic identification device with biometric data presented by a user. Biometric data may be any suitable biometric data, such as, for example, fingerprints, retinal scans, or voice recognition.

The invention is also directed towards a securable electronic identification device for displaying government furnished information (i.e., uploaded by a government agent) selected from the group consisting of government issued, for example, driver's license, social security card, identification card, and permit license. In addition, the device displays user information selected from the group consisting of, for example, credit card, health insurance card, bank card, library card, and store card.

The invention is also directed towards a secure electronic identification device (SEID) having communication logic and resources for communicating with a payment gateway and communication logic and resources for communicating with a second SEID. The SEID also includes a display, electrically connected to the logic and resources for displaying information developed by the communication and logic resources. The SLID also includes at least one secure memory area accessible by government systems for uploading and storing government data and a secure selectable government display mode for displaying the government data uploaded by the government systems. The government data is secured by a government furnished PIN, fingerprint data, or retina scan data. In addition the SEID includes a removable card, wherein the removable card includes a magnetic strip and an EMV chip. The SEID includes a magnetic encoder for encoding the magnetic strip and logic and resources for encoding the EMV chip.

In accordance with another embodiment of the present invention an electronic device having a banking module is provided. The banking module includes communication logic and resources for communicating with a payment gateway and communication logic and resources for communicating with a second SEID. The electronic device includes a display, electrically connected to the logic and resources for displaying information developed by the communication and logic resources. The electronic device also includes a removable card having a magnetic strip and an INV chip. The electronic device comprises a magnetic encoder for encoding the magnetic strip and the ENVY chip with information developed by the communication and logic resources.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a pictorial illustration of the internal configuration of the SEID in accordance with the present invention;

FIG. 2 is a pictorial illustration of the present invention in Driver's License mode in accordance the teachings of the present invention shown in FIGS. 1-4 and 11;

FIG. 3 is a pictorial illustration of a long side edge view of the SEID in accordance with the invention shown in FIGS. 1 and 11;

FIG. 4 is a pictorial illustration of a short side edge view of the SEID in accordance with the invention shown in FIGS. 1 and 11;

FIG. 5 is an illustration of a notional model for the operational SEID system in accordance with the present invention shown in FIGS. 1-4 and 11;

FIG. 6 is a method flow chart illustrating one process for SEID issuance and management in accordance with the present invention shown in FIGS. 1-4 and 11;

FIG. 7 is another pictorial illustration of the present invention in Driver's License mode in accordance the teachings of the present invention shown in FIGS. 1-4 and 11;

FIG. 8 is pictorial illustration of an example embodiment of a payment system showing the flow of data in accordance with the teaching of the present invention shown in FIGS. 1-4 and 11 in credit card mode;

FIG. 9 is pictorial illustration of an example embodiment of a payment system showing the flow of data in accordance with the teaching of the present invention shown in FIGS. 1-4 and 11 in bio pay mode;

FIG. 10 is pictorial illustration of an example embodiment of a payment system showing the flow of data in accordance with the teaching of the present invention shown in FIGS. 1-4 and 11 in receive mode; and

FIG. 11 is a pictorial illustration of the SEID showing, in part, removable SLIM card.

### DETAILED DESCRIPTION

The following brief definition of terms shall apply throughout the application:

The term “outer” or “outside” refers to a direction away from a user, while the term “inner” or “inside” refers to a direction towards a user;

The phrase “logic and resources” means hardware and for software components adapted to comprise a structural feature;

The term “comprising” means including but not limited to, and should be interpreted in the manner it is typically used in the patent context;

The phrases “in one embodiment,” “according to one embodiment,” and the like generally mean that the particular feature, structure, or characteristic following the phrase may be included in at least one embodiment of the present invention, and may be included in more than one embodiment of the present invention (importantly, such phrases do not necessarily refer to the same embodiment);

If the specification describes something as “exemplary” or an “example,” it should be understood that refers to a non-exclusive example; and

If the specification states a component or feature “may,” “can,” “could,” “should,” “preferably,” “possibly,” “typically,” “optionally,” “for example,” or “might” (or other such language) be included or have a characteristic, that particular component or feature is not required to be included or to have the characteristic;

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Specifically and by way of example, although the headings might refer to a “Field,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a limiting characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of the claims shall be considered on their own merits in light of this disclosure, but should not be constrained by the headings set forth herein.

Use of broader terms such as comprises, includes, and having should be understood to provide support for narrower terms such as consisting of, consisting essentially of, and comprised substantially of. Use of the term “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

An operational SEID system in accordance with the present invention is logically divided into the following three major subsystems:
SEID Front-End Subsystem—SEID, biometric readers, personal identification number (PIN) input device and ejectable SLIM card. The SEID interacts with these components to gain physical or logical access to the desired resource such as SEID issuance and management subsystem.
SEID Issuance and Management Subsystem—the components responsible for identity proofing and registration, key issuance and management, and the various repositories and services (e.g., public key infrastructure [PKI] directory, certificate status servers) required as part of the verification infrastructure.
SEID for storing user information, public information, and secure government information in memory sections having different read/write permissions. The SEID card also contains a GPS locator, GPRS module, ejectable SLIM card, and view/touch screen. The SEID card will be discussed in more detail herein.

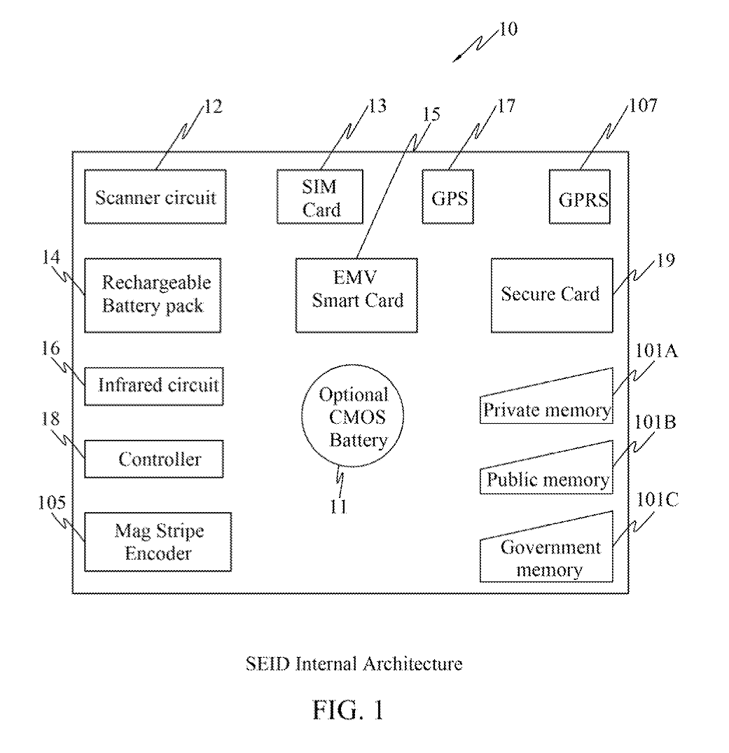

Referring to FIG. 1 there is shown a pictorial illustration of the internal configuration of the Secure Electronic Identification Device (SEID) 10 in accordance with the present invention shown in FIGS. 1-4, and 11. It will be understood throughout that SEID is an electronic device with having, substantially, a form factor conforming to ISO/IEC 7810 1D-1, ISO/IEC 7810 ID-2, or ISO/IEC 7810 ID-3 The internal configuration of the SEID includes a scanner circuit 12; a SIM card 13, a GPS module 17; a rechargeable battery pack 14, an EMV smart card 15, a secure card 19; an infrared circuit 16, a controller 18; an optional CMOS battery 11; a GPRS module 107, private memory area 101A, public memory area 101B, and government memory area 101C, each memory area having different read/write access controls and encryption features. For example, the government memory area may only be accessible by a user with a government supplied PIN and the private memory area may only be accessible by a user supplied PIN. GPRS module 107 with may include designated field access. For example to verify owner response against biometric profile, driver's license infringements like tickets or fees due and ability to pay them through the biometric verification gateway and approve individual card holder.

Still referring to FIG. 1, the scanner circuit 12 provides the circuitry necessary for scanning 1-D or 2-D barcodes. The scanning circuitry may be any suitable circuitry such as, for example, camera imaging and processing or laser scanning and processing. The scanning circuitry 12 may also be adapted to function as a biometric device, such as, for example, a fingerprint scanner for identification purposes.

Still referring to FIG. 1, the SEID 10 also includes a Subscriber identity Module (SIM) card 13. The subscriber identity module or subscriber identification module (SIM) 13 is an integrated circuit that securely stores an International Mobile Subscriber Identity (IMSI) and the related key used to identify and authenticate subscribers on mobile telephony devices (such as mobile phones and computers). The SIM card 13 contains its unique serial number (ICCID), international mobile subscriber identity (IMSI), security authentication and ciphering information temporary information related to the local network, a list of the services the user has access to and two passwords: a personal identification number (PIN) for ordinary use and a personal unblocking code (PUK) for PIN unlocking. It will be appreciated that a PIN is normally numeric but in the context of the invention described herein a PIN may also be alphanumeric.

Still referring to FIG. 1, the SEID 10 also includes GPS circuitry 17 for geographically localizing the location of the SEID Card 10. Localization information may be transmitted to suitable locations such as emergency locator systems and also displayed on the SEID 10 screen.

The SEID 10 includes a rechargeable battery pack 14 for powering the onboard circuitry. The rechargeable battery pack 14 may be fixed or removable. The SEID 10 also includes an optional CMOS battery 11 such as a lithium coin cell for backup power to critical circuits; such as the GPS circuitry 17, and the onboard real-time-clock (RTC) or system clock (not shown).

Still referring to FIG. 1, the SEID 10 also includes an Europay-MasterCard-Visa (EMV) smart card 15 feature. The EMV smart card 15 implements a global standard for inter-operation of integrated circuit cards (IC cards or “chip cards”) and IC card capable point of sale (POS) terminals and automated teller machines (ATMs), for authenticating credit and debit card transactions.

Also shown in FIG. 1 is a secure card module 19 for access by a government agency for identity proofing and registration discussed in more detail herein.

The SEID 10 also includes a controller 18 for controlling the various functions of the SEID including page or mode changing, infrared communications, download/upload commands, power maintenance, and data bus control and on/off functions.

Still referring to FIG. 1, the SEID also includes a magnetic strip encoder 105 for transferring information from the SEID to a SLIM card (discussed herein).

The controller 18 also controls access to the memory areas: user accessible area 101A, public accessible area 101B, and government accessible area 101C. The memory section 101 may be any suitable non-volatile memory such as flash memory. Controller 18 access to government accessible area 101C is modified by secure card module 19.

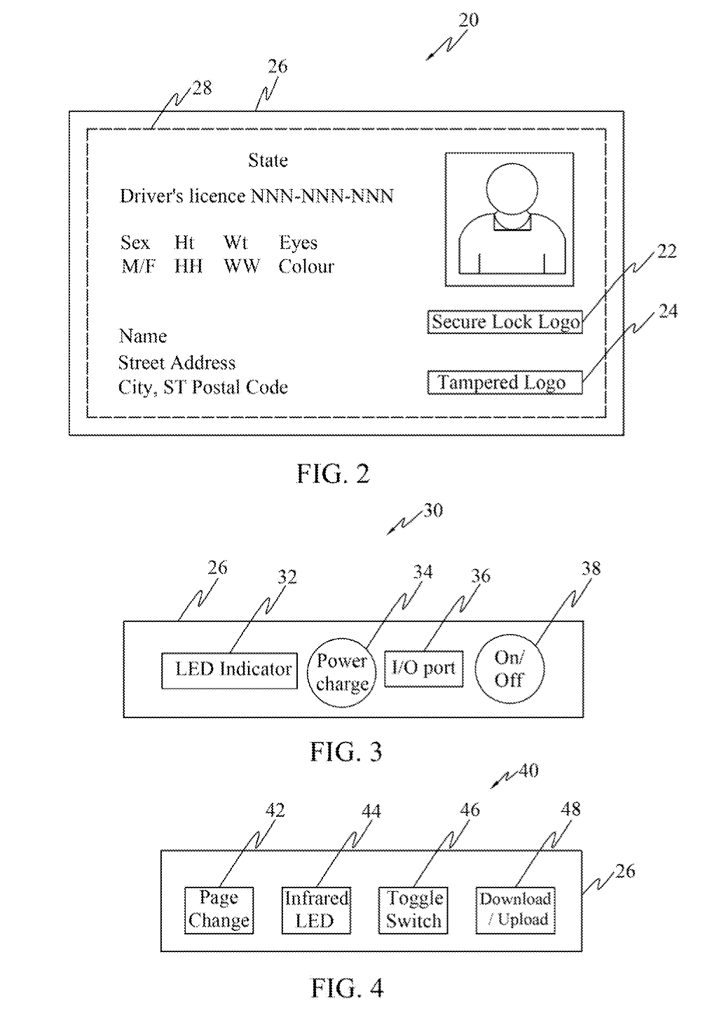

Referring also to FIG. 2 there is shown a pictorial illustration of the present invention in Driver's License mode 20 in accordance the teachings of the present invention shown in FIG. 1. In this mode the user's driver's license 20 is shown on the SEID 10 display area 28. The display area 28 may be any suitable type display, including, but not limited to, a touch screen such as a capacitive touch screen or a resistive touch screen. For power considerations, the SEID 10 display area 28 may also be a suitable non-touch screen such as an LCD type screen, e.g., TFT-LCD or IPS-LCD. Similarly, the SEID 10 display area 28 may also be a suitable non-touch screen such as an Organic Light Emitting Diode or OLED, e.g., AMOLED or Super AMOLED.

Also shown in FIG. 2 is SEID housing 26. SEID housing may be any suitable material, such as, for example a plastic or metal housing suitable for housing electronics.

It will be further understood that the user may make any of the display modes private, e.g., only accessible by the user, or, public, e.g., accessible by emergency personnel.

It will be further understood that certain data may be accessible by authorized personnel, e.g., police personnel in the performance of their duties, irrespective of the user set permissions. For example, upon surrendering the SEID 10 to police personnel the police personnel may access the driver's license mode to visually view driver license information by entering or scanning government authorization codes. Alternatively, the police personnel, or any authorized personnel may electronically query, via the infrared circuitry 16 and the aforementioned authorization codes, the SEID 10 to obtain certain information, e.g., driver's license information, electronically.

As will be discussed herein it will be appreciated that certain data displayed in certain modes may only be stored on the SEID via an authorized encryption process It will be further understood that attempts to tamper with encrypted data will result in permanent disabling of the “secure lock logo” 22 displayed in all display modes displaying encrypted or government furnished data. Permanent disabling the “secure lock logo” will result in the displaying of the “tampered logo” 24, thereby alerting a user or other authorized personnel that the SEID has been compromised and is no longer valid.

Still referring to FIG. 2, there is shown renewal display 23. Renewal display may be activated by government installed algorithms, e.g., calculated date expirations and or initiated by government signal via the GPRS module ((FIG. 1—107).

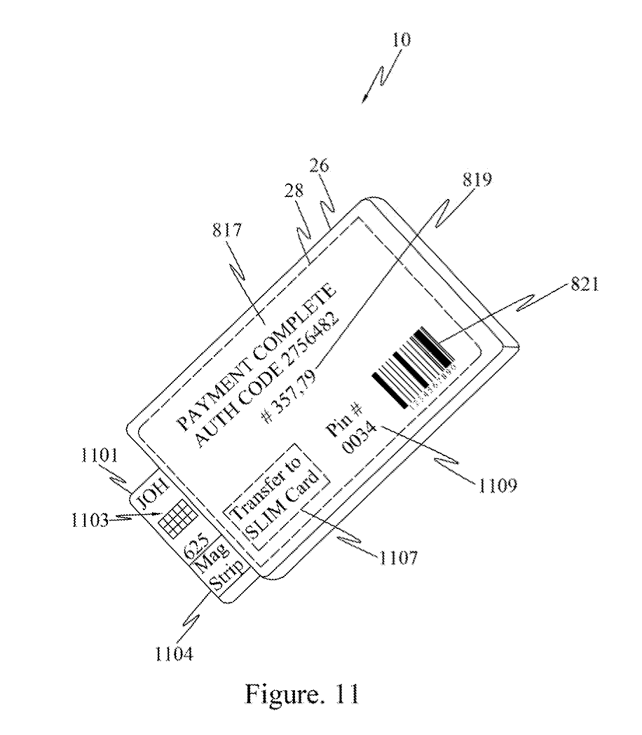

Referring also to FIG. 3, there is shown a short edge view 30 of the SEID Card 10 shown in FIG. 1 and FIG. 11. Optional is an LED indicator 32 for status indication such as on/off Also shown is a power charge indicator 34 for indicating the power charge status of the rechargeable battery pack 14 shown in FIG. 1.

FIG. 3 also shows an Input/Output port 36. The 110 port may be any suitable port for downloading or uploading information to the SEID 10. The I/O port 36 may also be any suitable port for concurrently charging the rechargeable battery pack shown in FIG. 1. For example, the I/O port 36 may be a universal serial bus (USB) rechargeable port. I/O port 36 may also incorporate wireless I/O features such as, for example, Bluetooth technology.

FIG. 3 also shows the on/off switch 38 for down powering the SEID device 10. It will be appreciated that the SEID device power management schemes may include multiple power management schemes for conserving battery life. For example, one power management scheme could turn off all displays after a pre-determined time.

Referring also to FIG. 4 there is shown a long edge view 40 of the SEID Card 10 shown in FIG. 1. Page/mode 42 change button changes the SEID Card 10 display. The SEID Card display may display multiple icons representing the various modes available and are highlighted and selected by the page/mode change button. As discussed earlier, suitable display modes may include a driver's license mode. Optionally, the SEID Card 10 may incorporate the features of the page/mode change button 42 to be included as a soft key feature available via the SEID Card 10 display area 28.

Still referring to FIG. 4 there is shown the infrared LED 44 for communication with other infrared communication devices. Also shown in FIG. 4 is a toggle switch 46 or button. The toggle switch 46 maybe used separately, or in conjunction, with the page/mode display 42 or other soft keys via the SEID Card touch screen 28 to toggle between various modes and screens.

Still Referring to FIG. 4 there is shown the upload/download switch 48. The upload/download switch 48 is used to direct the data flow from or to the SEID Card. The upload/download switch 48 may be used separately, or in conjunction, with other soft keys via the SEID Card touch screen 28 to direct the data flow from or to the SEID Card.

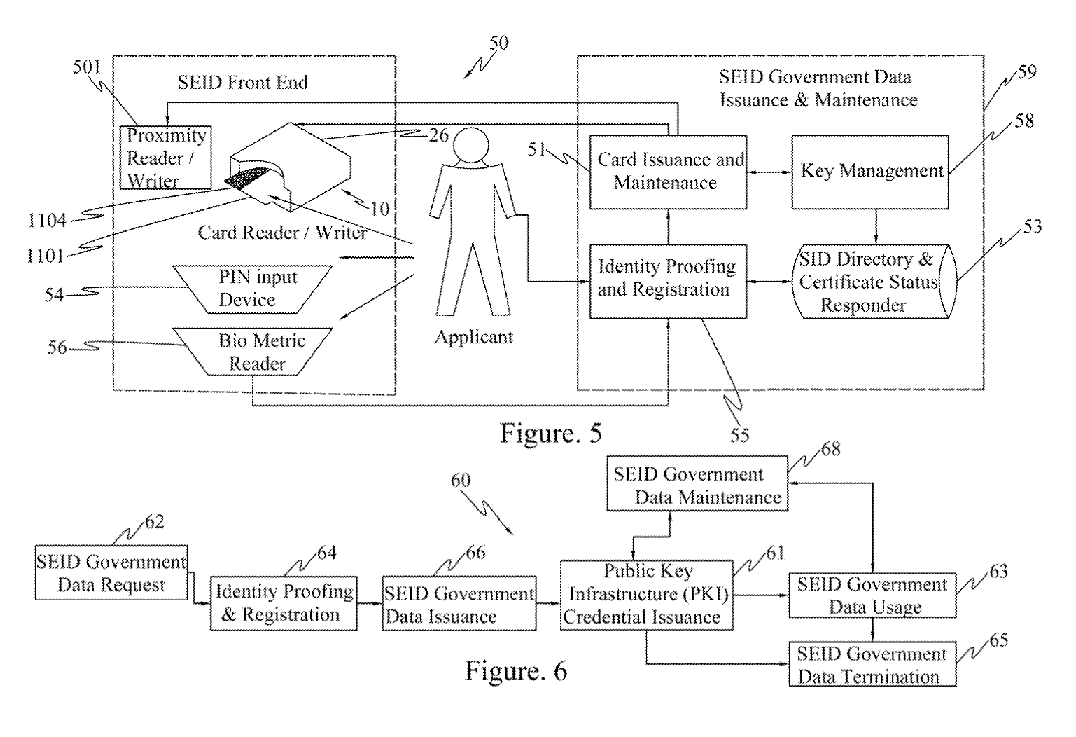

Referring also to FIG. 5 there is shown an illustration of the notional model for the operational SEID system 50 in accordance with the present invention shown in FIG. 1. The identity proofing and registration component 55 in FIG. 5 refers to the process of collecting, storing, and maintaining all information and documentation that is required for verifying and assuring the applicant's identity. Various types of identifying information may collected from the applicant at the time of registration; for example, but not limited to, birth certificate, biometric data.

The Data validator and maintenance component 51 deals with the personalization of the logical aspects of the card at the time of issuance and maintenance thereafter. This includes not only image downloads, names, and other personal identifying information (PII) data on the SEID Card, but also loading the relevant card applications, biometrics, and other data. A PIN entered via PIN input device 54 and/or user biometric data via Bio Metric reader 56 is used by the data validator and maintenance component 51 to control the ability to unlock the SEID Card 10 by the cardholder and then display the embedded credentials for authentication purposes. Bio Metric reader 56 may be any suitable biometric scanner such as, for example, a fingerprint scanner or a retinal scanner. Also shown in FIG. 5 is SLIM card 1101 (discussed further herein) and encoding strip 1104. Encoding strip may be any suitable encoding strip such as, but not limited to, a magnetic coding strip, a bar code, or any other suitable non-volatile encoding.

The key management 58 component is responsible for the generation of key pairs, the issuance and distribution of digital certificates containing the public key of the SEID holder, and management and dissemination of certificate status information.

The key management component 58 is used throughout the life cycle of the SEID 10—from generation and loading of authentication keys and PKI credentials, to usage of these keys for secure operations, to eventual renewal, reissuance, or termination of the SEID government data. The key management component 58 is also responsible for the provisioning of government accessible, or other suitable repositories and services (such as PKI directories and certificate status responders), that provide information to the requesting application about the status of the PKI credentials.

Still referring to FIG. 5, it will be understood that data validator and maintenance component 51 may communicate directly with SEID 10 via input/output ports discussed earlier or via wireless proximity reader/writer 501.

Referring also to FIG. 6 there is shown a method flow chart 60 illustrating one process for SEID government data issuance and management in accordance with the present invention shown in FIG. 5:
SEID Request 62. This activity applies to the initiation of a request for the issuance of SEID government data to be uploaded to SEID 10 and the validation of this request.
Identity Proofing and Registration 64. The goal of this activity is to verify the claimed identity of the applicant and that the entire set of identity source documents presented at the time of registration is valid.
SEID Government Data Issuance 66. This activity deals with the personalization (physical and logical) of the SEID and the issuance (upload) of the SEID government data to the intended applicant's SEID.
PKI Credential Issuance 61. This activity deals with generating logical credentials and loading them onto the SEID 10.
SEID Usage 63. During this activity, the SEID 10 is used to perform SEID authentication for access to a logical resource such as a secure memory location within the SEID 10. Access authorization decisions are made after successful cardholder identification and authentication.
SEID Maintenance 68. This activity deals with the maintenance or update of the SEID data stored thereon. Such data includes various SEID applications, e.g., PIN PKI credentials, biometrics and government (local or federal) access codes. In addition, government may initiate a renewal notification via GPRS module ((FIG. 1—107).
SEID Termination 65. The termination process is used to permanently destroy or invalidate the SEID government data and the data and keys needed for SEID 10 authentication so as to prevent any future use of the SEID 10 authentication. Termination of the SEID government data may be through I/O ports discussed earlier or proximity reader/writer 501. In addition, government may remotely initiate termination of government data via GPRS module (FIG. 1—107).

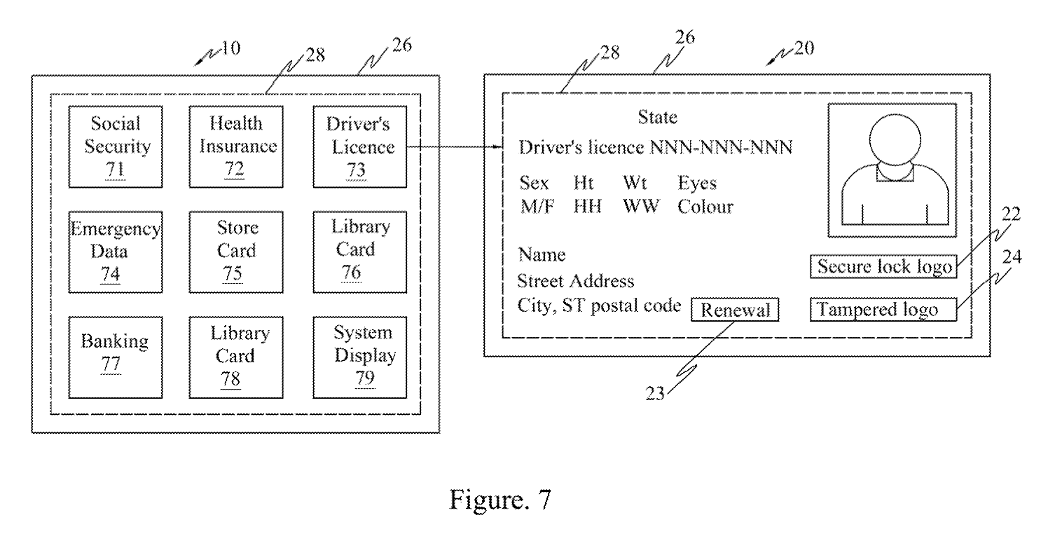

Referring also to FIG. 7 there is shown another pictorial illustration of the present invention in Driver's License mode in accordance the teachings of the present invention shown in FIG. 1. It will be understood that the SEID 10 display modes may include, in addition to the driver's license 20 display mode 73, a social security card display mode 71, a credit card display mode 77, a medical information display mode 74, or any other suitable display mode, such as for example, a library card 78, another library card 76, a store card 75, or health insurance 72. Other examples include gun permits, licenses such as hunting or fishing licenses, voter registration cards, insurance cards, and passport information.

Still referring to FIG. 7, Driver's License data is retrieved from (read only) government memory area 101C shown in FIG. 1 when soft-key 73 “driver's license” is selected. The user may require entry of the government supplied PIN before the government data is displayed. It will be understood that Driver's License data is stored or written to government area 101c by an authorized government agency in accordance with FIG. 5 and FIG. 6.

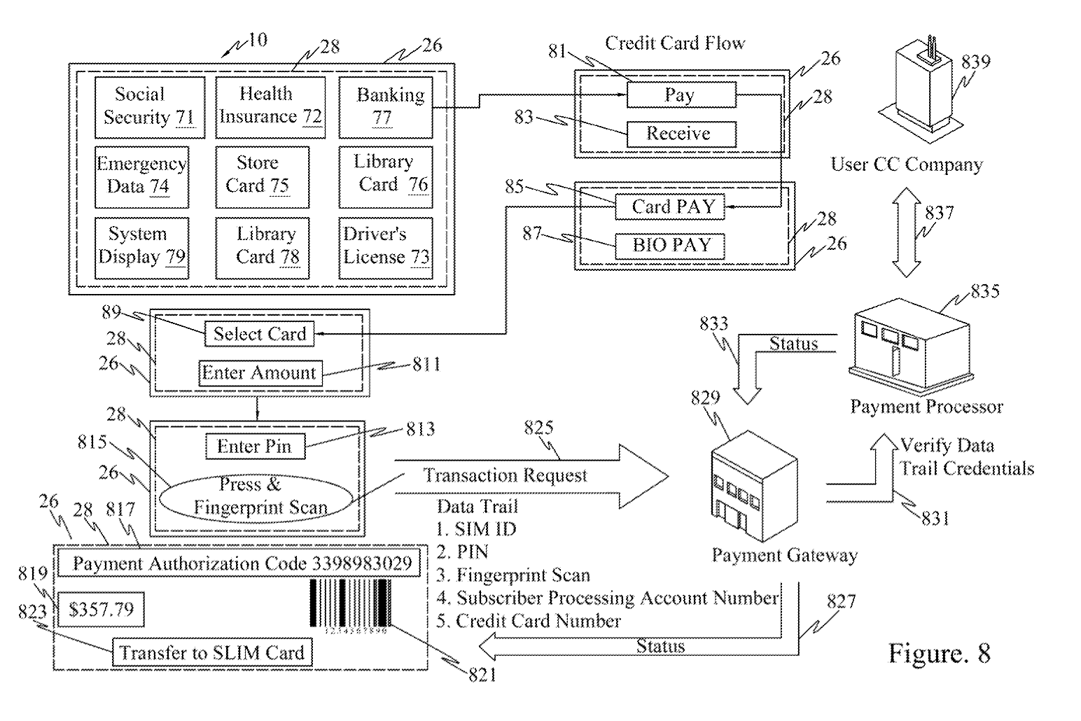

Referring also to FIG. 8 there is shown a pictorial illustration of an example embodiment of a payment system showing the flow of data in accordance with the teaching of the present invention shown in FIGS. 1-4 and 11 in credit card mode. Upon pressing or selecting banking icon 77 user is presented with pay 81 or receive options on display 28. Selecting pay 81 presents user with options of card pay 85 or bio pay 87. Selecting card pay 85 then presents user with a select card 89 option and an enter amount window 811. After selecting credit card and entering amount the user is presented with a PIN screen 813 for entering a personal PIN number. Next the user selects button 815 which scans fingerprint and initiates a transaction request 825 to the payment gateway 829. Transaction request 825 includes SIM ID, PIN, Fingerprint Scan data, Account Number, and Credit Card number. Certain portions of the transaction request may be encrypted.

Payment gateway 829 forwards the transaction request to the payment processor 835. The payment processor. The payment processor forwards the transaction request to the user's credit card bank or company 839. The user credit card bank or company 839 checks the transaction details for validity (e.g., card number, expiration date, funding limits, bio data, etc.)

The credit card company 839 responds with a status (e.g., approved (payment authorization code), declined, rejected, etc) to the payment processor 835 via path 837 which in turns forwards the status to payment gateway 829. Payment processor 835 forwards status via path 833 to payment gateway 829. Payment gateway returns the status via path 827 to display area 28. SEID 10 displays payment authorization code 817, approved amount 819, and barcode 821. It will be appreciated that barcode 821 may be any suitable code such as QR code. The user may provide the merchant with the authorization code 817 or the merchant may scan bar code 821 to complete the transaction. Also displayed is transfer to SLIM card option 823. The SLIM card option 823 will be discussed herein.

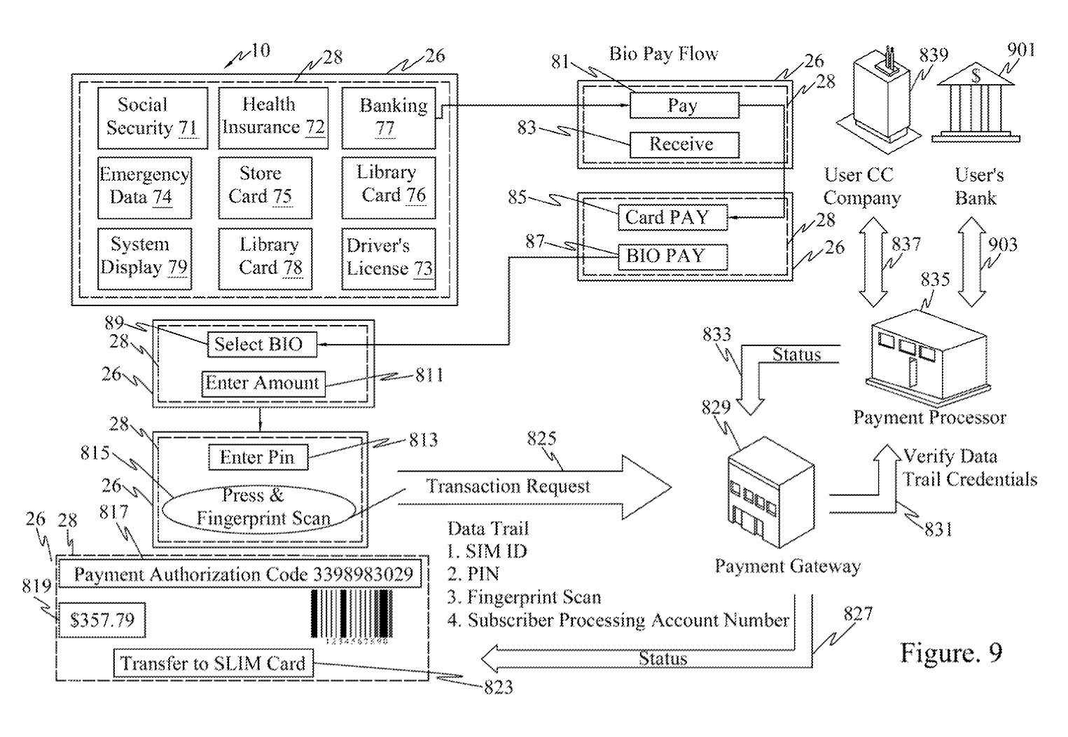

Referring also to FIG. 9 there is shown a pictorial illustration of an example embodiment of a payment system showing the flow of data in accordance with the teaching of the present invention shown in FIGS. 1-4 and 11 in bio pay mode. Upon pressing or selecting banking icon 77 user is presented with pay 81 or receive options on display 28. Selecting pay 81 presents user with options of card pay 85 or bio pay 87. User selects bio pay 87 which in turn presents user with bio select 89A. Bio select 89 selects from the desired bio data, e.g., fingerprint data, retinal scan, etc. It will be understood that the bio data may be associated with a bank account or credit card number.

After selecting desired bio data and entering amount the user is presented with a PIN screen 813 for entering a personal PIN number. Next the user selects button 815 which scans users fingerprint and initiates a transaction request 825 to the payment gateway 829. Transaction request 825 includes SIM ID, PIN, Fingerprint Scan data, Bio data, Account Number, and Credit Card number. Certain portions of the transaction request may be encrypted.

Payment gateway 829 forwards the transaction request to the payment processor 835. The payment processor. The payment processor forwards the transaction request to the user's credit card company 839 or the user's bank 901 depending upon the bio data association with either a bank account or a credit card number. The user credit card company 839 or bank 901 checks the transaction details for validity (e.g. card number, expiration date, funding limits, bank accounts, bio data, etc.) The credit card company 839 or user's bank 901 returns status information via pathways 837, or 903, respectively, to the payment processor 835.

The payment processor 835 forwards the status to payment gateway 829. Payment processor 835 forwards status via path 833 to payment gateway 829. Payment gateway returns the status via path 827 to display area 28. SEID 10 displays payment authorization code 817, approved amount 819, and barcode 821. It will be appreciated that barcode 821 may be any suitable code such as QR code. The user may provide the merchant with the authorization code 817 or the merchant may scan bar code 821 to complete the transaction. Also displayed is transfer to SHIM card option 823. The SLIM card option 823 will be discussed herein.

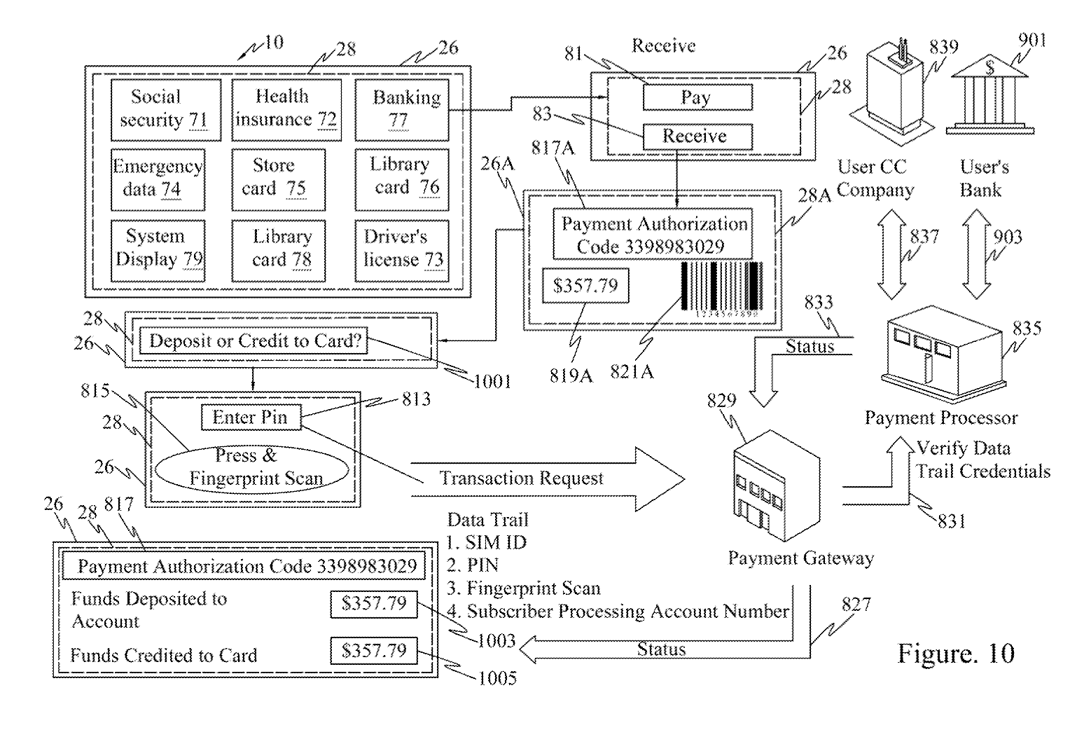

Referring also to FIG. 10 there is shown a pictorial illustration of an example embodiment of a payment system showing the flow of data in accordance with the teaching of the present invention shown in FIGS. 1-4 and 11 in receive mode. Upon pressing or selecting banking icon 77 user is presented with pay 81 or receive options on display 28. Selecting receive allows user to receive funds from another user's SEID 10A. SEID 10A displays payment authorization code 817A, amount in amount field 819A, and barcode 821A in display area 28A held by housing 26A. User may receive data via any of the input methods described herein. User is presented with option to deposit funds to user's credit card or bank 1001.

Still referring to FIG. 10 user is presented with a PIN screen 813 for entering a personal PIN number. Next the user selects button 815 which scans users fingerprint and initiates a transaction request 825 to the payment gateway 829. Transaction request 825 includes SIM ID, PIN, Fingerprint Scan data, Bio data, Account Number, Payment Authorization code, and/or Credit Card number. Certain portions of the transaction request may be encrypted.

Payment gateway 829 forwards the transaction request to the payment processor 835. The payment processor forwards the transaction request to the user's credit card company 839 or the user's bank 901 depending upon the user's selection 1001 (either a bank account or a credit card). The user credit card company 839 or bank 901 checks the transaction details for validity (e.g., card number, payment authorization code, expiration date, funding limits, bank accounts, bio data, etc.) The credit card company 839 or user's bank 901 returns status information via pathways 837, or 903, respectively, to the payment processor 835.

The payment processor 835 forwards the status to payment gateway 829. Payment processor 835 forwards status via path 833 to payment gateway 829. Payment gateway returns the status via path 827 to display area 28. SEID 10 displays payment authorization code 817, approved amount 1003, funds deposited to account 1003, and/or funds deposited to credit card 1005.

Referring also to FIG. 11 there is shown a pictorial illustration of the SEID 10 showing, in part, removable SLIM card 1101. SLIM card 1101 is a removable card having magnetic strip 1104, and EMV chip 1103. Also shown in FIG. 11 is Transfer to SLIM card option 1107 and PIN 1109. When option 1107 is selected and correct PIN 1109 is entered SEID 10 operates to encode the magnetic strip with encoder 105 (FIG. 1) and encodes EMV chip 1103 via controller 18 (FIG. 1). SLIM card 1101 having credit card form factor dimensions is then removable from SEID 10 and operates as a typical bank card.

Although an exemplary embodiment of the present invention has been shown and described with reference to particular embodiments and applications thereof, it will be apparent to those having ordinary skill in the art that a number of changes, modifications, or alterations to the invention as described herein may be made, none of which depart from the spirit or scope of the present invention. For example, the SEID 10 will also have the ability to perform card holder processing or self-processing (id pay technology). Cardholder will have the ability to process a payment request from their SEID device to the card issuer (i.e. bank, credit card Company, or bank account). The cardholder will have biometric ID and password on file and predetermined priority payment assignment selected. This will be on file with selected processor thus allowing for speed pay through id pay technology. This unique biometric identification and password will be in the data trail approving each and every transaction assuring and guaranteeing that the transaction could only have been initiated or can only be initiated through the correct biometric identification of the card holder. Once the processor receives requested amount by card holder, a unique bar code with identifier for the predetermined amount with payee approval code will display for merchant scan or print. The SEID device in idle state, the home page, can display the various user name and simple user data.

It will be appreciated that the novel features described herein creates a new paradigm shift in the payment processing industry for extreme high security in payment processing and protection of data. This eliminates to ever having to give or present a physical credit card to any merchant or anyone for any reason since payments are processed through the processor of the individual card holder.

What is claimed is:

1. A secure electronic identification device (SEID) comprising:
a housing comprising:
communication logic and resources comprising:
communication logic and resources for communicating with a payment gateway;
communication logic and resources for communicating with a second SEID; and
a display, electrically connected to the logic and resources for displaying information developed by the communication and logic resources.

2. The SEID as in claim 1 further comprising:
at least one secure memory area accessible by government systems for uploading and storing government data;
a selectable government display mode for displaying the government data uploaded by the government systems.

3. The SEID as in claim 2 wherein the government data comprises user bio data.

4. The SEID as in claim 3 wherein the user bio data comprises at least one user fingerprint data.

5. The SEID as in claim 3 wherein the user bio data comprises at least one retina scan data.

6. The SEID as in claim 2 wherein the selectable government display mode further comprises logic and resources for entering a government supplied personal identification number (PIN) to allow displaying the government data.

7. The SEID as in claim 1 further comprising:
at least one private memory area accessible by a user for uploading and storing user private data;
a selectable user private data display mode for displaying, the user private data; and
logic, and resources for entering a user supplied personal identification number (PIN) to allow displaying the private data.

8. The SEID as in claim 3 further comprising at least one biometric scanner.

9. The SEID as in claim 8 wherein the at least one biometric scanner comprises:
a fingerprint scanner for scanning a fingerprint; and
logic and resources for comparing the scanned fingerprint with the government supplied user bio data.

10. The SEID as in claim 8 wherein the at least one biometric scanner comprises:
a retinal scanner for scanning a retina; and
logic, and resources for comparing the scanned fingerprint with the government supplied user bio data.

11. The SEID as in claim 1 further comprising a GPRS module

12. The SEID as in claim 1 further comprising:
a removable card, wherein the removable card comprises:
a magnetic strip;
an EMV chip;
a magnetic encoder for encoding the magnetic strip; and
logic and resources for encoding the EMV chip.

13. The SEID as in claim 2 further comprising the logic and resources to verity the source of the government, user, or public furnished information and logic and resources for alerting if the information has been altered.

14. An electronic device comprising:
a banking module, wherein the banking module comprises:
communication logic and resources comprising:
communication logic and resources for communicating with a payment gateway;
communication logic and resources for communicating with a second SEID;
a display, electrically connected to the logic and resources for displaying information developed by the communication and logic resources;
a removable card, wherein the removable card comprises:
a magnetic strip;
an EMV chip; and
a magnetic encoder for encoding the magnetic strip and the EMV chip with information developed by the communication and logic resources.

15. The electronic device as in claim 14 wherein the communication logic and. resources further comprises a GPRS.

16. The electronic device as in claim 14 further comprising:
at least one secure memory area accessible by government systems for uploading and storing government data;
a selectable government display mode for displaying the government data uploaded by the government systems; and
logic and resources to verify the source of the government furnished information and logic and resources for alerting if the information has been altered.

17. The electronic device as in claim 16 wherein the government data comprises user bin data.

18. The electronic device as in claim 17 further comprising bio scanners for capturing user bio metrics and logic and resources for comparing the user bin metrics with the government stored user bio data.

19. The electronic device as in claim 14 further comprising an EMV chip fur implementing a global standard for inter-operation of integrated circuit cards (IC cards or “chip cards”) and IC card capable point of sale (POS) terminals and automated teller machines (ATMs), for authenticating credit and debit card transactions.

20. The electronic device as in 16 wherein the government data comprises data selected from the group consisting of government issued: driver's license, social security card, identification card, and permit license.
